(19) United States
(12) Patent Application Publication
(10) Pub. No.: US 2014/0078331 A1
(43) Pub. Date: Mar. 20, 2014

(54) METHOD AND SYSTEM FOR ASSOCIATING SOUND DATA WITH AN IMAGE

(71) Applicants: Kathleen Worthington McMahon, Woodside, CA (US); Bernard Mont-Reynaud, Sunnyvale, CA (US)

(72) Inventors: Kathleen Worthington McMahon, Woodside, CA (US); Bernard Mont-Reynaud, Sunnyvale, CA (US)

(73) Assignee: SOUNDHOUND, INC., San Jose, CA (US)

(21) Appl. No.: 13/621,161

(22) Filed: Sep. 15, 2012

(51) Int. Cl. H04N 5/232

(52) U.S. Cl. 348/211.99; 348/E05.024

(57) ABSTRACT

Embodiments of the disclosure disclose a method and system for associating sound-derived data with an image. The method includes receiving a signal to activate an image capture device. Upon activation, sound is captured along with capturing an image. After this, the captured sound is processed to generate sound identification data. Finally, the sound identification data is associated with the image.

### TECHNICAL FIELD

Broadly, the presently disclosed embodiments relate to sound identification and processing, and more particularly, to methods and systems relating sound data to image data.

### BACKGROUND

Music identification systems allow users to find music of their choice. Popular systems, such as SoundHound, allow a user to capture an audio segment and then identify a recording that matches that segment. In particular, these systems provide an application running on a mobile device, which allows the user to capture an audio segment using a single tap or pushbutton on the user's device. The captured segment can be a recording, singing, or humming, and may include background noise as well. The captured segment is transmitted over a network to a remote audio identification server, which attempts to identify the segment and transmits the results back to the mobile device. To summarize, these systems capture sound and compare the captured sound with a library of recordings stored in a database. When a match is found, a sound ID is returned along with derived information including meta-data, such as a song title, artist name, album name, and lyrics, or in-context links to music distributors, music services and social networks. Alternatively, a match may be found by a speech recognition system, and a keyword or sequence of words may be returned as text, possibly with time tags, creating another type of sound-derived data. The sound-derived data is also called sound identification data.

Other music search and discovery systems employ text-based systems, which allow users to find songs by inputting lyrics, keywords, or other data. Such systems require more user knowledge and interaction than do the sound-based systems.

Users also can access a number of systems to work with video recordings or still images, captured by the user herself or originating from pre-existing material. Current techniques allow videos to be associated with time stamps and geo tags. What the art has not made possible is associating audio IDs and music meta-data or spoken words with and simultaneous image material. Audio identification and image recording technologies exist separately, and users cannot capture and identify a momentary audio experience along with simultaneous visual material. Thus, there exists a need for identifying and interacting jointly with visual and audio data.

### SUMMARY

Embodiments of the present disclosure disclose a method for associating sound-derived data with an image. The method includes receiving a signal to activate an image capture device, and perhaps a signal to end the capture. Upon activation, the image capture device captures sound along with capturing an image. The captured sound is then processed to generate sound identification data. The sound identification data is associated with the image. The image here includes a video or a still image. The sound-derived identification data may include a transcription for speech, or audio or music meta data.

Other embodiments of the disclosure describe a system for attaching sound-derived data with an image. The system includes a receiving module configured to receive a signal to activate an image capture device. The image capture device is configured to capture a sound while capturing an image. The system further includes a processing module configured to process the captured sound to generate sound identification data. Moreover, the system includes an associating module that is configured to automatically associate the sound-derived identification data with the captured image. This may be done in several ways.

### BRIEF DESCRIPTION OF THE DRAWINGS

FIG. 1 illustrates an exemplary embodiment of the present disclosure.

FIG. 2 discloses a method flowchart illustrating a process for associating sound-derived data with an image.

FIGS. 3A, 3B, and 3C are exemplary snapshots of an image capture device, a video taken from the image capture device, and a sound associated video respectively.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows. Definitions

The term “associating” includes stamping, attaching, associating, or jointly processing audio and video material. The phrase “image” includes one or a sequence of still images, or a video. Further, the phrase “captured sound” refers to the content of an audio recording and includes singing, speech, humming, or other sounds made by a person or otherwise present in the environment. Captured sound includes any sound that is audible while capturing the image. A “fingerprint” provides information about the audio in a compact form that allows fast, accurate identification of content. Those skilled in the art will understand that the definitions set out above do not limit the scope of the disclosure. The term “captured image” will include both still and video images unless the context indicates otherwise.

### Overview

Broadly, the present disclosure relates to sound identification and processing. More specifically, the disclosure discloses a method and a system for associating sound with an image. Each time an image is captured, a captured sound that includes song, speech, or the like is also captured simultaneously. Thereafter, the captured sound is processed to include sound identification data. Finally, the sound identification data is associated with the image. The captured sound may include a broadcast audio stream, such as a song from a radio station or television. Alternatively, captured sound may include a recording played on a stereo system, or live sound such as live music or a person speaking, singing or humming. Based on the type of sound, the system processes the captured sound and associates the sound identification data with the image. Later, a user, when desired, can search for the association using audio meta-data and retrieve the image content and its tags, or conversely search images or tags and retrieve sound ID and related data.

### Exemplary Embodiment

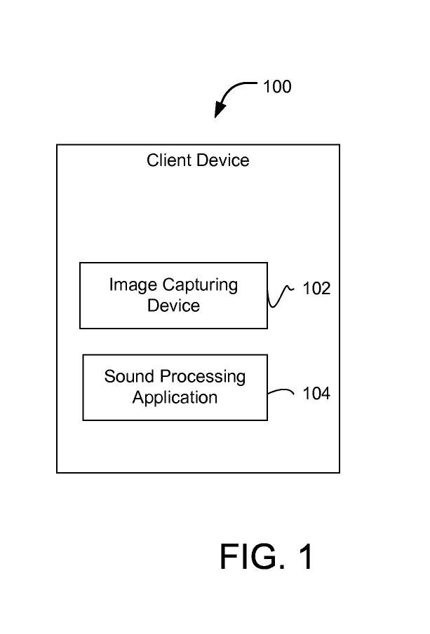

FIG. 1 is a block diagram of a system 100 capable of associating sound data with an image according to the present disclosure. The system 100 includes two primary elements: an image capture device 102 and sound processing application 104, which elements will be discussed below in detail. The system 100 can be a mobile device capable of receiving an input and displaying an output, and it may include other functional and structural features not relevant for the purpose of the present disclosure and which will not be described in further detail here. Various examples of the mobile device include, but not limited to, mobile phones, smart phones, Personal Digital Assistants (PDAs), or similar devices. In the context of the present disclosure, the system 100 includes image capture device 102 that is integrated with a sound capture device (not shown). In addition, the system 100 includes the sound processing application 104 capable of processing sound information and displaying output as desired. In many embodiments, the sound processing application 104 may reside over a network or server (although not shown). The sound processing application 104 receives sound captured by sound capture device and creates sound identification data accordingly.

The image capture device 102 performs the conventional function of capturing an image that includes a video or still image. The image capture device 102 may form a part of the illustrated mobile device, or in some embodiments, it may be a stand-alone device. In the context of the present disclosure, the image capture device 102 captures sound while capturing the video, and this sound—or a part of it—is used for identification. The sound is captured for use with the sound capture device that is integrated with the image capture device 102.

In an alternative embodiment, a still image is captured, and the sound may be captured by the sound recording device, starting at the time of the snapshot and lasting for (say) 10 seconds. In a further variant, the sound recording device could make use of a pre-buffer, which allows access to the last few seconds of audio, so that the captured sound associated with a snapshot can go from (say) 5 seconds before to 5 seconds after the time of the snapshot.

Using one of the alternatives just listed, audio that is essentially simultaneous with the image material has been captured. Once captured, data that identifies the sound is generated and is then automatically associated with the video or still image. Here, the sound identification data is also referred to as sound/audio ID. Finally, the association between audio ID and video or still image is stored in a database. The database here can include a memory component associated with the mobile device or can be a separate component, or an external software module. The association record may include sound ID meta-data, such as song title, artist name, album name, current lyrics, time stamp, goo tug, and still image or video data. Such associations can be stored locally on the system 100, mobile device, remotely within the audio ID server system, or passed along to other local or remote systems, such as image-based systems or social networks.

Once the association has been stored in different ways for different purposes, searching by one field or another becomes possible. User name, time or geo tag, music meta data and even image content may all serve as the basis for specialized search interfaces. In an alternative embodiment, annotations may be shared with external systems, such as iPhoto and other existing or future image software that supports image annotations. For example, on the iPhone, a user's collection of images (photos and videos) are seen on the Camera Roll screen, and the associated geo tags are shown on a Places screen. With audio ID tagging, it can be envisioned that in a similar manner there will be a “Sounds” or “Songs” screen that shows the audio tags—perhaps grouped by genre or by audio type. Other variations of the use of audio IDs will amount to “SoundHound meets Instagram” or “SoundHound meets Facebook.”

In other embodiments, the system 100 may include a number of modules, such as receiving module, capture module, processing module, associating module, a storage module, or others. These modules perform operations required to associate sound data with the image.

### Exemplary Flowchart

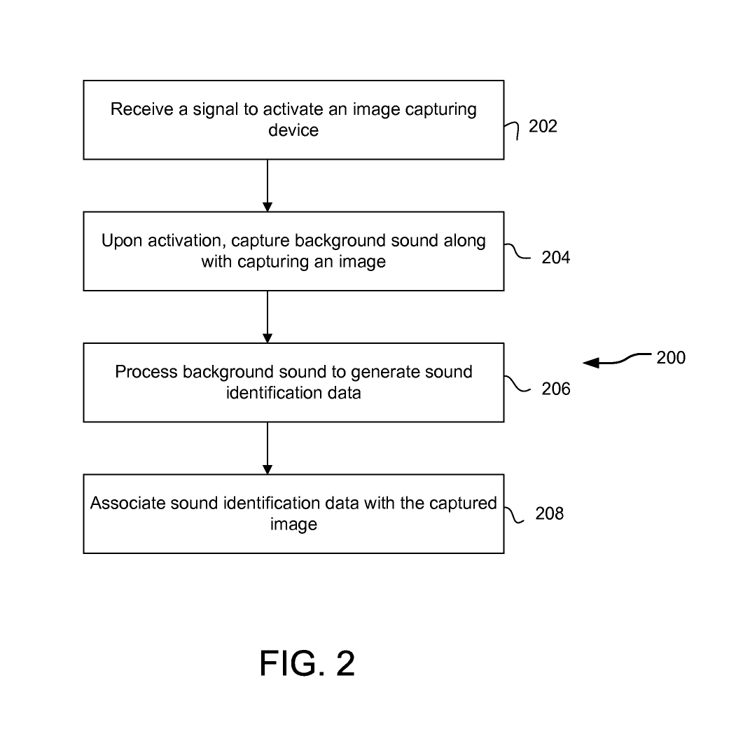

FIG. 2 sets out a flowchart 200 for a method disclosed in connection with the present disclosure. Particularly, FIG. 2 is a method flowchart illustrating a process for associating sound data with an image. The method begins with receiving a signal from a user to activate an image capture device at 202. Upon activation, a sound capture device may also be activated. In general, the image capture device captures a video or a still image, but in the context of the present disclosure, the image capture device captures a sound along with capturing a video or still image at 204. The captured sound may include, but not limited to, recorded music or live music, speech, singing and humming.

After this, the sound is processed to generate sound identification data at 206. Processing of the captured sound includes analyzing sound, or filtering noise. The method also includes the step of identifying the type of sound and based on its type, captured sound is processed. For example, if the sound involves lyrics, speech, or conversation, the relevant parts of the sound may be converted into text. But, if the sound includes a humming sound, the humming sound may be matched with a melody stored over a network, and a music recording with a known entry in a database of recordings. Once the sound identification data is generated, it is associated with the captured still image or video at 208. If sound identification data is not generated for some reasons, the user can input that data, accordingly, the video or still image can be associated. In certain embodiments, the video or still image can include multiple associations.

In one embodiment, processing the sound includes converting the captured sound into text. Afterward, at least a portion of the text is attached to the captured image. The attached text can be used for a similar captured image in a library of stored images. Before attaching the text to the captured image, the text can be validated by the user. Thereafter, the captured image associated with the sound data is stored in a database. A number of algorithms including sound to text conversion, or sound to transcription are available, and an appropriate choice can be implemented as required. Otherwise, sound to text conversion can be accomplished through an Application Program Interface (API). In some embodiments, the text can be displayed to the user while capturing the video image.

In embodiments, where the captured sound includes humming or singing, the method includes the steps of generating fingerprints. The generated fingerprints are transmitted over a network to a server, which matches the generated fingerprints with a plurality of pre-stored fingerprints/sounds and retrieves one or more matched sounds from the network. Finally, the retrieved sounds are transmitted back to the mobile device. As a next step, a user of the mobile device selects one of the retrieved sounds and finally, the selected sound is attached to the captured video or still image by the associating module 106.

Additionally, the method includes attaching data and time or location information with the captured image. Those of skill in the art will be able to devise suitable techniques for analyzing captured sound, obtaining derived data, applying most suitable algorithms, and storing image associations in the appropriate formats for various applications. In additional embodiments, the associated video can be shared with other users through Facebook, or other social networking websites. The application 104 provides an option of viewing various associated images as a slide show. In the slide show option, the actual sound data may be played while displaying the video; similarly, a still image may be displayed while playing the associated audio.

For the sake of understanding, an example is described herein. In an example, it can be considered that a user wishes to capture a video of his birthday party; accordingly, the user activates the camera of his mobile device. This activation also activates an integrated sound capture device. The integrated system then captures sound while also capturing the video image. The sound may include birthday wishes or blessings, singing voices, and so on. Here, the sound association application 104 processes the captured sound and analyzes its context. Based on that analysis, the application 104 interprets the content as a birthday celebration for a person named David; accordingly, the application 104 associates the video with the content—“Happy Birthday David.” In another embodiment, the user may dictate a subject line, so that the application 104 may associate the video with the phrase—“David Birthday celebration.” After associating or before storing the video, the application 104 asks the user to validate the attached tag or may ask the user to modify the association if needed. Once the task is accomplished, the associated video is saved in the user's mobile device.

In another example, rather converting the singing/spoken sound into text, the melody of the song can be captured and matched with pre-stored sounds. Accordingly, one or more matched sounds and various versions may be retrieved and can be displayed to the user. Finally, the user can choose one of the versions that can be attached to the captured image or, anticipating the system's ability to identify music, the user could hum a few bars of the Paul Simon song, “At the Zoo,” which could be retrieved and added to the associated sound track.

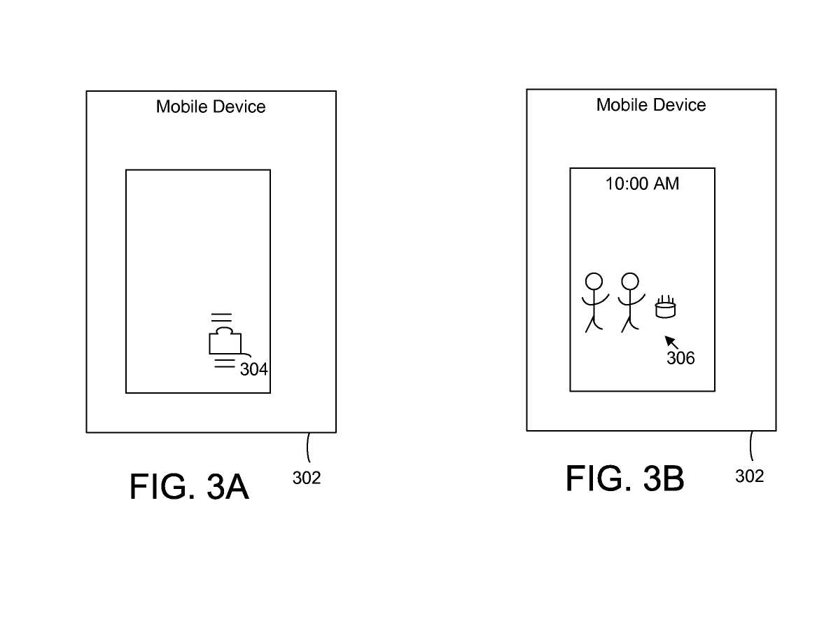

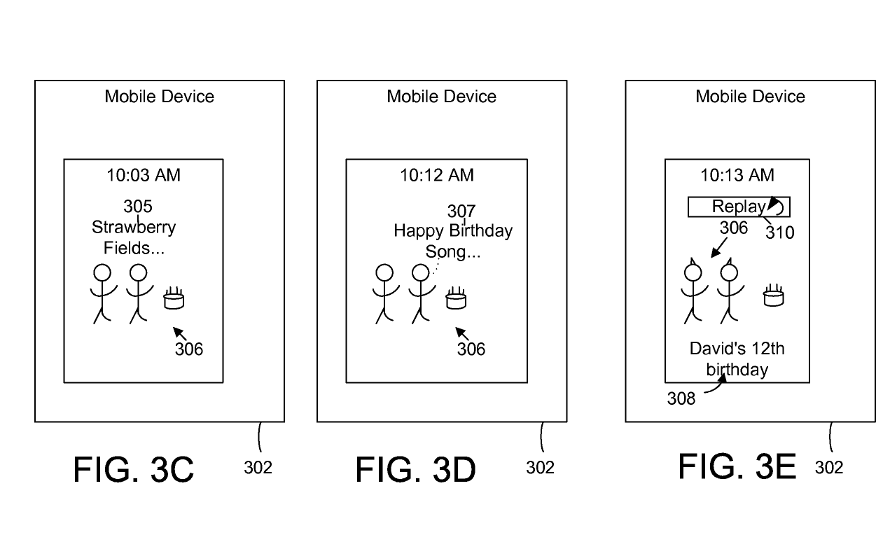

FIG. 3A shows an exemplary mobile device 302 having an image capture module 304—a camera, for example, and a sound capture device (not shown), such as, a microphone. The illustrative module 304 can be activated with a single tap on a touch screen, for example, or by a single keystroke, depending on the nature of the mobile device. Upon activation, the module begins capturing the video shown as 306 in FIG. 3B, while also capturing the sound. After processing, the sound identification data or the transcribed text , “Happy Birthday”, for example, is associated with the video 306.

More particularly, FIG. 3B shows the device displaying the video 306 that starts at 10:00 AM. While capturing the video 306, a song “Strawberry Fields Forever” (marked as 305) by John Lennon and Paul McCartney is heard at 10:03AM (at this particular moment, it may be considered that the candles are not lit), as shown in FIG. 3C. This song is captured by the sound capture device. Further, FIG. 3D shows that the “Happy Birthday” (marked as 307) song is heard (sung around the cake—now with lit candles) at 10:12am. After capturing the video 306 along with the sound—songs, in this case, the sound is processed to generate sound identification data, as discussed above. As one example, the sound identification data may include—“David's 12^{th} birthday” as 308, in FIG. 3E. Finally, the sound identification data—“David's 12^{th} birthday” 308 is associated with the video 306 as shown in FIG. 3E. As a next step, the video 306 associated with the sound data is saved in a database. In particular, FIG. 3E illustrates the video 306 can be replayed marked as 310.

In another example, assume that a user attends a live performance, perhaps at her children's school, and she wants to make a video or short movie of that show. Accordingly, she activates the camera of her mobile device. The camera's integrated sound capture system captures the singing along with the video. Here, the application converts the captured sound into fingerprints and then matches those fingerprints with entries in a library of fingerprints pre-stored on the network. Subsequently, one or more matched fingerprints are retrieved and then displayed on the user's device. As a result, the user selects one of the matched sounds and associates the selected sound with the video, enabling searches by content as described earlier.

In this manner, the user will later be able to retrieve the images from the song, or the song from the images or from having posted a share on a social network. In another embodiment, all of the matched sounds and their associations are kept along with the video. These might be used as subtitles or as other forms of annotation of the video in one of a number of existing formats. The specification has described a method and system for associating sound data with an image. Those of skill in the art will perceive a number of variations possible with the system and method set out above. These and other variations are possible within the scope of the claimed invention, which scope is defined solely by the claims set out below.

What is claimed is:

1. A method for associating sound-derived data with an image, comprising:
receiving a signal to activate an image capture device;
upon activation, capturing sound along with capturing an image using the image capture device;
processing the captured sound to generate sound identification data; and
automatically associating the sound identification data with the captured image.

2. The method of claim 1, further comprising automatically activating a sound capture device upon activating the image capture device.

3. The method of claim 1, wherein the captured sound includes at least one of: spoken sound, singing sound, humming sound, a broadcast stream played over a media channel, or a recorded sound played on a playback device.

4. The method of claim 3, further comprising processing the captured sound, based on the type of sound.

5. The method of claim 1, further comprising converting relevant parts of the captured sound into text.

6. The method of claim 5, wherein at least a portion of the text is associated with the captured image.

7. The method of claim 5, further comprising searching for at least a portion of the captured image in a library of pre-stored images, using the portion of the text.

8. The method of claim 5, further comprising displaying the text simultaneously while capturing the image.

9. The method of claim 1, wherein the association between sound identification data and an image is stored in a database.

10. The method of claim 1, wherein the sound identification data is validated by a user.

11. The method of claim 1, wherein the image includes at least one of a still image or a video.

12. The method of claim 1, further comprising filtering noise from the captured sound.

13. The method of claim 1, further comprising matching the captured sound with a plurality of pre-stored sounds.

14. The method of claim 13, further comprising retrieving one or more matched sounds.

15. The method of claim 14, further comprising extracting meta-data associated with the matched sounds.

16. The method of claim 15, further comprising associating the meta-data with the captured image.

17. The method of claim 14, further comprising attaching at least one of the matched sounds with the captured image.

18. The method of claim 1, further comprising attaching the date and time information with the captured image and its sound association.

19. The method of claim 1, further comprising attaching location information with the captured image and its sound association.

20. A system comprising:
a receiving module configured to receive a signal to activate an image capture device;
the image capture device configured to capture sound while capturing an image;
a processing module configured to process the captured sound to generate sound identification data; and
an associating module configured to automatically associate the sound identification data with the captured image.

21. The system of claim 20, further comprising a sound capture device that is integrated with the image capture device.

22. The system of claim 20, further comprising a storage module configured to store the captured image associated with the sound identification data.

23. The system of claim 20, wherein the processing module is configured to convert the captured sound into text.

24. The system of claim 23, wherein at least a portion of the text is attached to the captured image.

25. The system of claim 20, further comprising a display module configured to display the text simultaneously while capturing the image.

26. A mobile device comprising:
an application configured to:
receive a signal to activate an image capture device, the activation includes activation of a sound recognition device;
capture sound along with capturing a video or a still image;
process the captured sound to generate sound identification data; and
automatically associate the sound identification data with the captured image.
